(19) United States
(12) Patent Application Publication
(10) Pub. No.: US 2018/0073343 A1
(43) Pub. Date: Mar. 15, 2018

(54) Method and System for Subsea Purification of Produced Water From Subsea Oil Producing Installations

(71) Applicant: Seabed Separation AS, Trondheim (NO)

(72) Inventor: Otto Skovholt, Trondheim (NO)

(21) Appl. No.: 15/559,182

(22) PCT Filed: Mar. 16, 2016
(86) PCT No.: PCT/NO2016/050048

§ 371 Date: Sep. 18, 2017

(30) Foreign Application Priority Data
Mar. 16, 2015 (NO) 20150331
Feb. 8, 2016 (NO) 20160209

(51) Int. Cl. E21B 43/36; B01D 17/02; B01D 19/00; B01D 21/24; C02F 1/20; C02F 1/40

(52) U.S. Cl. CPC E21B 43/36; B01D 17/0214; B01D 19/0042; C02F 2001/007; C02F 1/20; C02F 1/40; B01D 21/2494

(57) ABSTRACT

The present disclosure is related to a method and system for subsea purification of produced water in a subsea installation comprising a tank assembly for separating gas, oil, sand and other minerals and water by means of gravitational forces and retention time, as well as releasing purified water and storing of sand and other mineral particles for a long period, including many years.

### BACKGROUND

The present disclosure is related to a method for subsea purification of produced water from subsea oil producing installations.

The present disclosure is also related to a system for subsea purification of produced water from subsea oil producing installations.

The present disclosure relates generally to a method and system for subsea purification of produced water from subsea oil producing installations by the arrangement subsea tank assembly providing separation of gas, oil, sand and water by means of gravitational forces and retention time, as well as storage capacity for polluted sand.

Separation of oil fluids from oil wells results in respective separated fluid streams comprising different compositions. The respective fluid streams are denoted phases and it is common to have separation systems providing for example three phases, one phase of gas, another of oil and a third phase comprising produced water. Together with the produced water, a variable quantity of sand and other mineral particles may follow. Other components in produced water are in particular PAH-compounds, benzene, toluene, xylene, ethyl benzene, alkyl phenols and phenols, although usually in very small quantities. An example of a separator system is disclosed in the international patent application WO 2014096330.

Providing separation of fluids in subsea installations may provide advantages compared to separation systems located in some distance away, for example located above sea level on platforms, or on land. Backpressure reduction in pipes connected to the oil well is an important feature and known in the prior art. Reduction in backpressure may provide an increase in oil production and even in the total oil field output and is achieved when the separation system is located close to the oil well.

When performing separation of fluid phases in a subsea installation, release of produced water directly into the surrounding seawater is an environmental hazard, and strict official regulations and permits are usually regulating and governing such operations. Therefore, arrangements providing online purification of oil fluids including produced water are of great interest.

An example of a prior art solution is the CTour Process, which is based on a principle of adding light hydrocarbon fluids, such as condensate or LPG to the oil comprising produced water, in order to dissolve heavier oil components into light hydrocarbons. The lighter hydrocarbon mixture is easier to separate into respective oil residues residing in the water either by gravity or by a cyclone device as known in prior art. The known CTour Process equipment is designed primarily for use on platforms.

Another prior art process purifying produced water in a subsea installation is based on flotation; it is named OiW Process (Oil in Water) (http://www.oiwprocess.no/about-us/). The method claim to be able to reduce the content of oil in water below 5 PPM (part per million).

Another prior art solution is the EPCON CFU subsea installation that is based on a gas floatation technique. Internal devices in the subsea equipment wherein residual gas is released from the water aid the separation process, gas is added, or both processes are done. Oil droplets then agglomerate and coalesce which facilitate separation from the water.

Another prior art solution applied at the Tordis field in the North Sea, is based on drilling a separate well into an aquifer, which is a water filled reservoir, and simply dump the polluted water there. In this particular case, the well failed and water leaked out into the sea. Apart from such possible failures, the cost involved will normally become very high, often between 0.5 to 1 billion NOKs.

A further prior art solution of handling produced water and sand in subsea separation systems is based on sending produced water and sand in a separate pipeline to a platform for treatment. This solution is costly and the treatment capacity on the platform is often limited. Further, produced water includes amounts of gas, which could result in explosion danger.

A further proposed prior art solution is injecting the produced water back into the oil and gas reservoir that it came from. New experiences show that this solution has disadvantages, even a very low content of oil in the injected water may harm the reservoir properties and thereby reduce the recovery of oil from the reservoir. If sand is part of the injected water this is also harmful to the reservoir properties, since sand may cause clogging and reduces the porosity of an oil containing formation. Sand should therefore be removed in a separate process by a so-called de-sander device before water is injected into the reservoir, and then brought back to the oil flow and removed at the platform. Therefore, injection of produced water for disposal purpose is not a desired solution unless the produced water is purified almost to the same low level of oil content being required by regulations permitting direct release into the surrounding sea.

From WO2015004138 A1 it is known a method and system for oil production in remote deep-water areas. Processing of the produced oil from subsea oil wells is partly being performed subsea on a subsea oil and gas production unit (DPS), whereas the remaining processing takes part on a vessel that may be disconnected from the DPS if the conditions makes it necessary. This solution requires separate tanks for separating the different phases and further is not arranged for storage of sand.

In AU 489334 B1 it is described a settling tank for water entrained solids, and is especially related to a settling tank for use in relation to a concrete manufacturing and mixing plant containing a concrete batching plant or batcher in which the concrete is mixed. The settling tank is employed to permit settling and holding of deposits which are too small to gravitate out of the entraining water during its passage through the tank. This solution is however not suitable for being arranged under water and is further only arranged for removing solid particles, i.e. not capable of providing separation of gas, oil and water.

WO 2005121495 A1 is related to a device in plants for collecting particles sedimented from water, the plant having a number of sedimentation chambers which are separate from one another by means of a partition wall, the partition wall being provided with at least one opening for transferring water from the one chamber which has at least one inlet to the second chamber which has at least one outlet, and that the opening is located under the inlet to the one chamber and under the outlet from the second chamber. This solution is not adapted for being arranged in subsea areas and is further only adapted for sedimentation of different types of solid particles i.e. as earth and rock debris, from water, i.e. not arranged for separating oil, gas and water.

Hence, it is a desire for an improved system and method thereof purifying separated water from subsea oil producing installations would be advantageous, and in particular, a more efficient and/or environmental friendly subsea system and method would be advantageous.

### SUMMARY

The present disclosure provides a method and system providing subsea purification of produced water from subsea oil producing installations partly or entirely solving the above mentioned drawbacks of prior art.

It is further an object of the present disclosure to provide a method and system providing subsea purification of produced water from subsea oil producing installations by separation of gas, oil and water in three phases by means of gravitational forces and retention time.

An additional object of the present disclosure is to provide a method and system providing long term and high volume storage of oil polluted sand.

It is further an object of the present disclosure to provide a method and system providing removal of oil, gas and sand from produced water from subsea oil producing installations allowing purified water to be released directly into the surrounding sea.

Further objects of the present disclosure will appear when considering the following description, claims and attached drawings.

Offshore oil and gas producing installations extract fluids from oil wells in subsea formations comprising a certain amount of free water, denoted produced water, as discussed above. However, the amount of water vary from none to small amounts of water when producing gas, while when producing oil there may be very small amount of water initially when starting production from a well, while the amount of water may increase to more than 90% of total fluid volume towards the end of the oil fields production lifetime. Together with the produced water most often it follows a certain amount of sand and other mineral particles, referred collectively to as sand. The amount of sand may vary substantially. This is due to geological properties of the formation the oil field is located.

After separation of produced water and sand from the produced fluids from a well, it is always some residual oil content that must be removed from the water as well as sand before being allowed to release produced water into the sea. This process is often denoted produced water purification. According to public regulations in some jurisdictions, produced water must be purified below 30 PPM according to e.g. the international OSPAR convention. However, reduction below 5 PPM is preferable and is a goal for many produced water purification systems.

The present disclosure provides a method and system for produced water purification based on separation of oil, gas, water and sand by gravitational forces and retention time in a subsea tank assembly.

As oil is usually lighter than water and therefore it is only a question of time before a mixture of oil and water is split into pure oil and water due to gravitational forces, and because there is no chemical bonding between water and oil as such. Experiments with light oil at room temperature being dispersed into water by powerful shear forces creates small oil droplets that needs approximately three days before being separated into pure water and pure oil by gravitational influence. When oil is less dispersed in water, which implies emulsion with larger oil droplets, the time will be less.

Heavy oil fluids with high specific weight closer to the specific weight of produced water will need even more increased separation time if the droplets are small as discussed above. Therefore, it is important for any produced water purification system to prevent small droplets, which is caused by high shear forces. It is known, for example, that reduction of oil pressure at inlet valves of separator systems may provide high share forces. Therefore, it is preferable to utilize a high-pressure separator system in connection with a produced water purification system based on separation by gravitational forces and retention time.

Handling of sand is also an important issue. The amount of sand will vary considerably from one oil field to another. For example, oil wells of the Tordis field in the North Sea produces approximately 400 kg of sand per day, and in volume approximately 200 litres, which amounts to an amount of 73 m³ per year. At the Gullfaks, field wells are producing about 2 kg sand per day, equivalent to approximately 30 m³ per year.

The temperature of oil fluids is also an important part when enhancing gravitational separation of oil droplets due to temperature dependent changes in the rheological properties of both water and oil. In addition, with higher temperature, dissolved gas combined with reduced pressure will cause release of free gas in both water and oil, which enhances the purification process. Therefore, it is preferable to preserve the well flow heat by insulating a produced water purification system as well as further equipment located upstream.

These numbers regarding sand must be compared to actual volumes of produced water. For example, the Tordis field has a produced water flow rate of 15.000 m³per day.

Accordingly, the method and system according to the present disclosure are arranged to solve both the purification demand and the demand for handling of sand, by utilizing a subsea tank assembly including at least one tank, where the tank assembly being provided with at least one inlet arranged at a distance below upper part of the tank and at least one outlet arranged at a distance below the upper part of the tank. In the same manner at least the outlet is also arranged a distance over the lower part of the tank assembly. The arrangement of the inlet with a distance from the upper part of the tank assembly is to ensure that supply of produced water does not interfere with separated oil and gas in the tank assembly, as this will result in that the oil and/or gas will be mixed with the water again. The arrangement of the outlet with a distance from the upper part and the lower part is to ensure that when purified water is to be extracted from the tank assembly, sand from lower part of the tank assembly or oil or gas from upper part of the tank assembly will not be extracted with the purified water.

The inlet(s) will typically be arranged to one or more subsea separators providing a flow of produced water into the tank assembly, wherein the produced water will contain water and sand together with rests of oil and gas from the subsea separator(s). The flow of produced water from the subsea separator(s) into the subsea tank assembly is preferably so low that minimal turbulence is created, and can be controlled by e.g. the arrangement of a manifold at the inlet(s) of the tank assembly.

The subsea tank assembly will have a storage capacity reflecting the necessary retention time of fluids in the tank assembly to achieve separation by gravitational forces, separating sand and other minerals from the flow, which will sink to the bottom of the tank assembly, while oil (droplets) and gas which will rise to the top of the tank assembly, and water which will be positioned between the sand and the oil and gas at the top of the tank assembly. Accordingly, due to gravitational forces and the retention time, the result will be an oil phase, a gas phase, and a water phase between the oil phase and sand. Accordingly, in the present disclosure there is no need for separate tanks for these phases.

Further, at least one oil and gas outlet, or separate oil outlet and one gas outlet, is/are arranged at the top of the tank assembly to allow oil and gas to be extracted from the tank assembly. Further, a pump will typically be arranged to the oil outlet to pump the oil to the surface or to an oil outlet from the oil producing installation.

The tank assembly can be formed by one tank having sufficient storage capacity or a tank divided in several compartments. The tank assembly can further be formed by an assembly of two or more tanks or tank segments provided with openings in sidewalls thereof to allow fluid flow therebetween.

In the case of the tank including several compartments or several tanks/tank segments arranged to each other, the sidewalls between the separate compartments or tanks are preferably provided with at least one opening at upper part to allow uninterrupted flow of oil and gas between the compartments or tanks. It will further be preferable to arrange at least one an opening in the mid area of the sidewalls between the separate compartments or tanks to allow flow of water and/or sand between the separate compartments or tanks. It could also be preferable to arrange at least one opening also in the lower area of the separate compartment or tank to allow flow of sand (and water) between the separate compartments or tanks.

Outlets for oil and gas can in such cases be arranged in each tank or compartment, or at the tank or compartment positioned farthest from the inlet of the tank assembly, i.e. the tank or compartment closest to the water outlet of the tank assembly.

Further, the tank assembly can be provided with several inlets to allow for adjustments if the amount of sand in the tank or compartment is increasing too high.

In a sense, designing a tank assembly providing separation by gravitational forces, the tank assembly must be designed in view of the respective different parameters of oil fluids influencing, not just by temporary properties of the oil fluids at the time when designing and installing the tank assembly, but also in view of changing time dependent properties of oil fluids and oil well properties over the production life time of the oil field, accordingly a produced water purification system that is adaptable to changing parameters.

Further, as the present disclosure provides a system which can be easily modified, if necessary during the lifetime of an oil field, the storage capacity of the tank assembly will have to be increased; a number of extra tanks may be installed and connected to the existing tank assembly installation.

According to the present disclosure, the outlet of the tank assembly can be arranged to an optional degassing module for further purification. Accordingly, the output water from the tank assembly, being mainly free from oil and sand, partly free from gas, is led to the degassing module which is operated by adjustment of temperature, pressure or supplying chemicals thereby releasing remaining dissolved gas.

A method for purification of produced water according to the present disclosure can be summarized as follows:

supplying separated produced water containing water and sand together with rests of oil and gas from subsea oil producing installations to an inlet at one side of a subsea tank assembly, where the inlet is arranged at a distance from upper part of the tank assembly not interfering with oil and gas phases,

separating by means of gravitational forces and retention time the produced water into a gas phase, oil phase and water phase, as well as sand, and

releasing purified water to surrounding sea via an outlet at opposite side of the subsea tank assembly, where the outlet is arranged at a distance from upper part of the tank assembly not interfering with the oil and gas phases.

The method can further include extracting separated gas by means of a gas outlet arranged on top of the tank assembly, i.e. in communication with the gas phase.

The method can further include using at least one compressor for extracting gas from the gas outlet of the tank assembly.

The method further includes extracting separated oil by means of an oil outlet arranged in upper part of the tank assembly, i.e. in communication with the oil phase.

The method can further include using at least one pump for extracting oil from the oil outlet of the tank assembly.

The method can further include the use of a degassing module arranged in fluid communication with the outlet of the tank assembly, and operating the degassing module by adjusting temperature, pressure or supplying chemicals for releasing remaining dissolved gas before releasing purified water to the surrounding water.

The method can further include extracting separated gas from the degassing module by means of a gas outlet arranged on top of the degassing module.

The method can further include using at least one compressor for extracting gas from the gas outlet of the degassing module.

The method can further include the use of a pump for extracting purified water from the degassing module.

The method can further include accumulating gas and oil in the tank assembly for extraction at desired intervals to a oil installation at the surface or after the field is closed down/abandoned.

The method can further include transferring gas back to a gas output of the subsea oil producing installations and/or oil back to an oil output of the subsea oil producing installations continuously or at desired intervals.

The method can further include setting retention time by experiment wherein a sample of produced water is kept in a glass container and measuring the time it takes for a separation by gravitational forces to occur. It also possible to add some extra time to the estimate to make sure the separation by gravitational forces will be fulfilled.

The method can further include measuring amount of produced water with sand being separated from a subsea separator with a fluid flow or volume meter.

The method can further include, after the retention time is identified, estimation of actual volume of sand by the amount being separated in the glass container.

The method can further include the initial step of arranging the tank assembly on a concrete platting on a seabed.

The method can further include a step of extracting the accumulated sand to a sand treatment installation at the surface after the filed is completed/abandoned by adding sea water to the tank assembly and pumping the accumulated sand to the sand treatment installation at the surface for removing of rests of oil in the sand.

The method can further include a step of filling the tank assembly with sand after the field is completed/abandoned and sealing the tank assembly with concrete, thus safely depositing the polluted sand.

Accordingly, the present disclosure provides a solution where purified water can be released directly into the surrounding sea, and further providing storage of oil polluted sand over an extended period of time, preferably over years or even over the total life span of the field, by providing a large storage tank assembly located on the sea floor enabling sufficiently long retention time for oil droplets in the produced water to rise to the upper part of the tank and sand and other mineral components to sink to the bottom of the same tank assembly and being accumulated there over a time span being dictated by the total storage capacity of the installation.

Further preferable features and advantageous details of the present disclosure will appear from the following example description.

### BRIEF DESCRIPTION OF THE DRAWINGS

The present disclosure will below be described in more detail with references to the accompanying drawings, where:

FIGS. 1a and 1b illustrate principle drawings of a system according to the present disclosure,

FIGS. 2a and 2b illustrate an example of tank segments components according to the present disclosure and deployment of the tank segments,

FIG. 3 illustrates principles of operating an embodiment example according to the present disclosure, and

FIG. 4 illustrates an alternative embodiment of the present disclosure.

### DETAILED DESCRIPTION

The attached figures illustrates examples of embodiments of the present disclosure and is not to be construed as being limiting to other possible embodiments falling within the scope of the attached claim set.

Although the present disclosure has been described in connection with the specified embodiments, it should not be construed as being in any way limited to the present examples. The scope of the present disclosure is set out by the accompanying claim set. In the context of the claims, the terms “comprising”/“comprises” or “including/includes” do not exclude other possible element or steps. In addition, the mentioning of references such as “a” or “an” etc. should not be construed as excluding a plurality. The use of reference signs in the claims with respect to elements indicated in the figures shall also not be construed as limiting the scope of the disclosure. Furthermore, individual features mentioned in the different claims, may possibly be advantageously combined, and the mentioning of these features in the different claims does not exclude that a combination of features is not possible and advantageous.

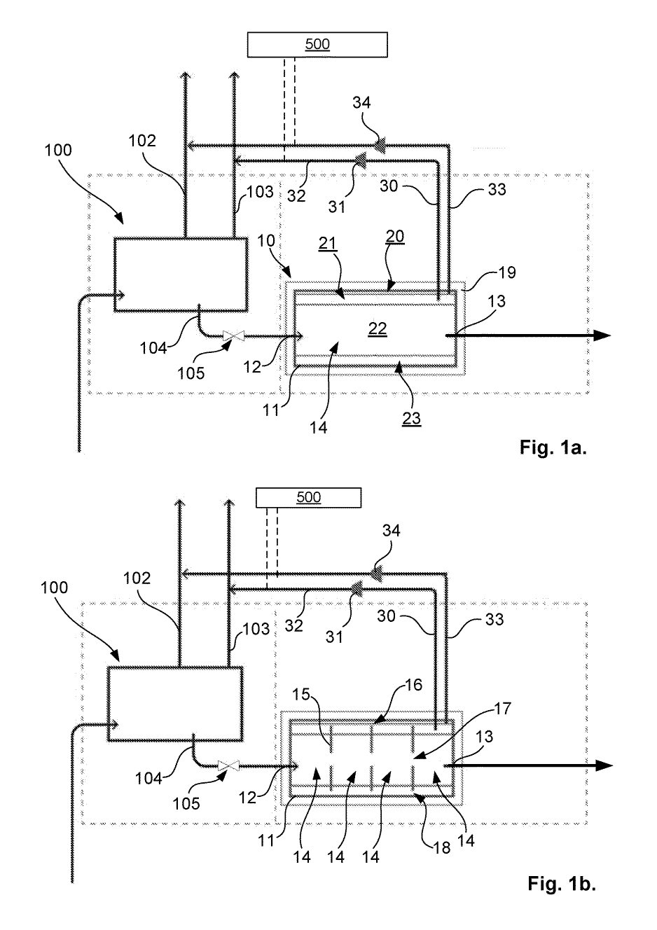

Reference is now made to FIGS. 1a-b showing principle drawings of a system according to the present disclosure. FIG. 1a shows a principle drawing of a first embodiment of the present disclosure, while FIG. 1b shows a principle drawing of a second embodiment of the present disclosure.

According to the present disclosure the system includes a tank assembly 10 including at least one tank 11 provided with an inlet 12 at one sidewall thereof (left hand side of the tank assembly 10) and an outlet 13 at the opposite sidewall thereof (right hand side of the tank assembly 10). The inlet 12 is in fluid communication with a subsea oil producing installation 100 as shown in more detail in FIG. 3. FIG. 3 shows an example of a prior art separator system where dual separators 101a-b separate gas 102 and oil 103 and produced water 104 from both the gas and oil separation. The separator can be of the type disclosed in WO 2014096356.

In FIG. 1a it is shown a tank assembly 10 including one large tank 11 with only one compartment 14. In FIG. 1b it is shown a tank assembly 10 including one large tank 10 with multiple compartments 14.

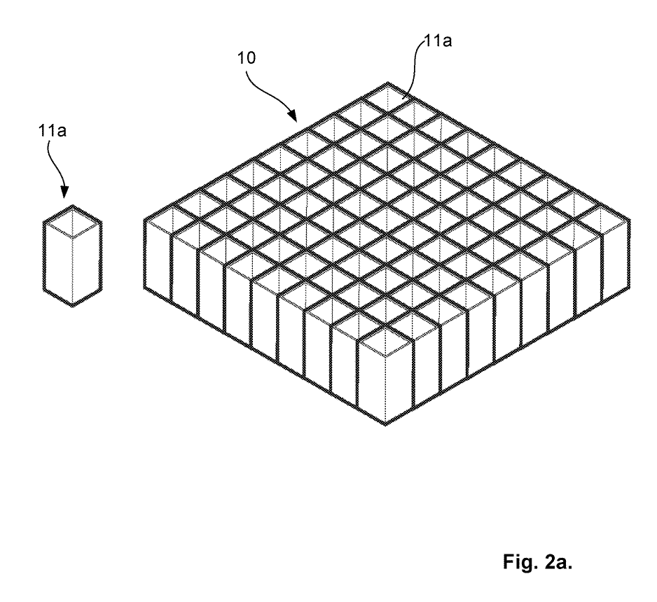

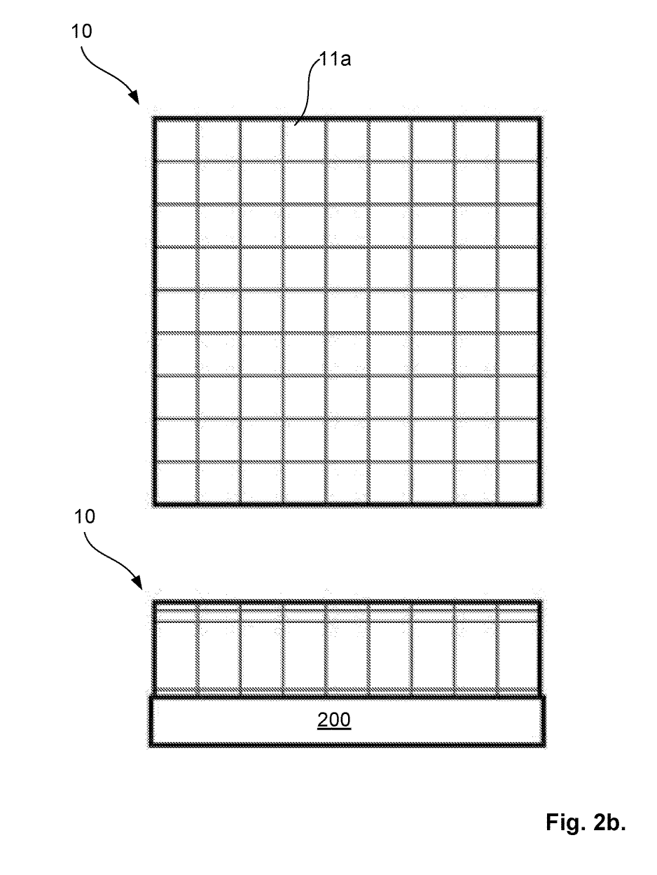

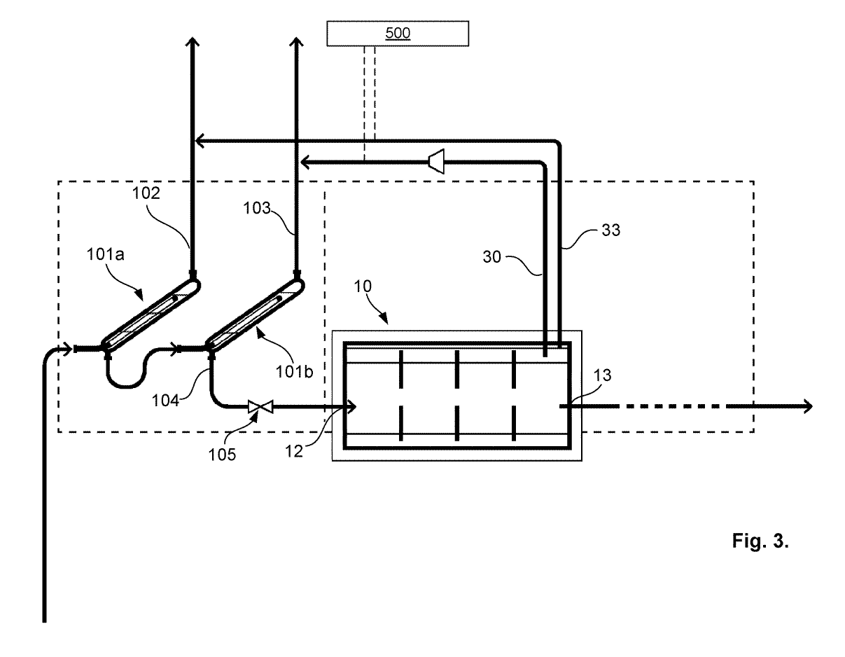

A tank assembly 10 including multiple compartments 14 can be formed in different ways, as e.g. shown in FIG. 1b where partition walls 15 are arranged in the tank 11 to provide multiple compartments 14. Another way of achieving this is by arranging two or more tank segments 11a to each other, as shown in FIGS. 2a-b to form a tank assembly 10 formed by multiple tank segments 11a arranged in a grid covering the total size of a desired tank assembly 10.

When the tank assembly 10 includes multiple compartments 14 or tank segments 11a, there is arranged at least one opening 16 at upper part of the tank segments 11a or partition walls 15 to allow free flow of oil and gas at upper part of the tank assembly 10.

It will further be necessary to arrange at least one opening 17 in middle or low area of the tank segments 11a or partition walls 15 to allow free flow of water and sand between the compartments 14 or tank segments 11a.

In the example in FIG. 1b it is shown at least one opening 18 in lower part of the tank segments 11a or partition wall 15 to allow sand to flow from one compartment 14 or tank segment 11a to the adjacent.

According to the present disclosure the tank assembly 10 is preferably arranged on a concrete platting 200 arranged at the seabed, as shown in FIG. 2b.

The shape and size (volume) of the tank assembly 10, hereunder tank segments 11a and compartments 14, are designed such that deposited sand on the bottom of each tank segment 11a/compartment 14 can be accumulated over many years before the sand has to be removed, as well as retention time before water is released to the outlet.

The dimensioning of a tank assembly 10 is possible to do when the necessary retention time is identified. According to an aspect of the present disclosure, it is possible to assess the retention time by a simple experiment wherein a sample of produced water is kept in e.g. a glass container. By measuring the time, it takes to see that separation by gravitational forces actually has occurred it is possible to assess the retention time. It is also possible to add some extra time to the estimate to make sure the separation by gravitational forces will be fulfilled. Measuring the amount of produced water with sand being separated from a separator can also be done with a fluid flow or volume meter. After the retention time is identified, the actual volume of sand can also be identified by the amount being separated in the glass container. Based on these figures it is possible to arrive at a correct dimension of a tank assembly 10 for an actual installation.

Further, due to the large difference in water volume and sand volume, the tank assembly 10 may be equipped with a sand trap making it possible to store separated sand for years in the tank assembly 10 before it is necessary to remove sand from the tank assembly 10.

The opening(s) 17/18 arranged between adjacent tank segments 11a/compartments 14 defines the size of the sand trap by adjusting the height of the location of the opening(s) 17/18 above the bottom of the each tank segment 11a/compartment 14.

The necessary volume for storing sand is a parametric choice of design. However, it is beneficial to allow storage of sand over a number of years since this enables possible small amounts of oil being dissolved in the sand to dissipate through the porosity of the sand and rise to the upper part of the tank assembly 10. When the accumulated volume of sand reached the allocated volume in the tank assembly 10, the accumulated sand can be removed e.g. by pumping it up and deposit it on the seabed if it is pure enough, or pump the sand to a ship for further processing. This possible extra step of purifying sand could be performed with many years in between or after the field is abandoned/completed.

Relatively small tanks 11/tank segments 11a are assumed to be manufactured effectively at low cost out of steel, while larger tanks 11/tank segments 11a are assumed easier to construct out of concrete. Concrete tanks 11/tank segments 11a, such as storage cells used in concrete oil producing platforms in the North Sea, have been proved feasible for oil and water storage as these are designed to withstand external water pressure and operated at about equilibrium pressure.

With reference to FIG. 2a, the data obtained from the Tordis field in the North sea a tank assembly 10 according to the present disclosure may be assembled by a plurality of cubical tank segments 11a each having a volume of 1280 m³, and by assembling eighty-one tank segments 11a covering an area of 72 m×72 m×20 m the total tank assembly 10 volume is 103680 m³. This volume allows purification of produced water of 15000 m³ a day with an identified retention time of 7 days. The volume of each tank segment 11a is such that deposited sand on the bottom of each tank segment 11a can be accumulated over many years before the sand has to be removed.

The produced water 102 from the subsea oil producing installation 100 is led to the tank assembly 10 via the inlet 12. If the tank assembly 10 includes multiple compartments 14 or tank segments 11a the flow will be distributed to all other tank segments 11a/compartments 14 located close to the sidewall of the tank assembly 10 facing towards the subsea oil producing installation 100. The separation by gravitational forces of the produced water 104 will result, when viewed from the top, in a gas layer 20, followed by an oil layer 21, a water layer 22 and sand and other mineral particles 23 at the bottom, accordingly providing a gas phase, oil phase and water phase in addition to sand.

In this regard it is important that the inlet 12 of the tank assembly 10 is arranged at a distance from the gas and oil phases to avoid mixing them with water again. It is further important that the outlet 13 of the tank assembly 10 is arranged at a distance from both the oil and gas phases, as well as the sand, to avoid oil or gas or sand to be flushed out with the purified water at the outlet It will further be preferable to provide the tank assembly 10 with an insulated layer 18 to preserve the temperature from well flow as temperature affect the separation properties.

According to the present disclosure the tank assembly 10 is preferably a sealed tank assembly to provide an interior environment with equilibrium pressure.

Further, there is preferably arranged a pressure reduction valve or manifold 105 between the subsea oil producing installation 100 and the inlet 12 of the tank assembly 10 to reduce the pressure of the produced water 104.

When the tank assembly 10 includes a grid of parallel compartments 14/tank segments 11a, the inlet 12 from the s subsea oil producing installation 100 can be distributed to each separate parallel section via a manifold (not shown) arranged on the outside of the tank assembly 10.

Further, the outlet 13 of purified water can be arranged separately for each respective parallel connected tank segments 11a/compartments 14 or joined by a manifold (not shown) arranged at the outlet 13. In some embodiments this can be advantageous, as will be discussed further below.

The oil 21 in the oil layer can for example be collected by a manifold section 30 being integrated into a roof covering a tank assembly 10 such that each tank segment 11a/compartment 14 can be emptied individually or collectively or just a subsection of tank segments 11a/compartments 14, for example those located close to the outlet 13 side are emptied.

When the identified retention time has elapsed, sand 23 has been separated and rests on the bottom of tank segments 11a/compartments 14 while oil 21 is floating to the top and can be extracted by the manifold section 30 by a pump 31 to extract the oil from the tank assembly 10. The oil can be extracted continuously via an oil pipeline 32 to the main oil output 103 from the separator 101b, the pump 31 adjusting the pressure to the outlet pressure of the separator 101b, or the oil 21 can be accumulated over a desired time an extracted to the main oil put 103 or to a surface oil (and gas) production unit 500. A further option is to accumulate the oil 21 until the field is completed/abandoned and extract the oil 21 to a surface oil (and gas) production unit 500 at this stage.

Further, in the same manner gas 20 can be extracted by a pipe 33 leading gas 20 back to the main gas 102 outlet from the separator 101a and a compressor 34 is installed to adjust the pressure to the outlet pressure from the separator 101a continuously or at desired intervals, the gas 20 can be extracted to a surface (oil and) gas production unit 500 at desired intervals or continuously or the gas can be accumulated until the field is completed/abandoned and extracted to the surface (oil and) gas production unit 500 at this stage.

Accordingly, gas and oil can be extracted continuously, at desired intervals or be accumulated over the entire operating time of the field before extraction.

According to an example of embodiment of the present disclosure, the tank assembly 10 is filled with seawater before start of operating the tank assembly 10. In this manner, there will be almost the same pressure inside the tank assembly 10 as outside the tank assembly 10. This simplifies the construction of the tank assembly 10. At start of operation, seawater will be pushed out. After the retention time has elapsed, purified produced water will be pushed out of the tank assembly 10.

It is important to understand that this process is a continuously running process, i.e. produced water 104 is continuously being fed into the tank assembly 10, but after the retention time has elapsed, at least the tank segments 11a/compartments 14 located on an opposite side of the inlet 12 will comprise separated gas 20, oil 21, sand 23 and water 22. The produced water 104 entering the tank assembly 10 can be viewed as a slowly moving wave that will be damped by the opening(s) 16-18 between the tank segments 11a/compartments 14. In a sense, the water streaming into the tank assembly 10 will be more and more laminar when passing the opening(s) 16-18, which will induce a calm environment with little turbulence that either wise could degrade the separation process result. It is also readily understood that when starting operation of an installation according to the present disclosure, one should wait the duration of the retention time before extracting oil or gas while the water can start flowing since when starting it is seawater that is streaming out of the tank assembly 10. When the first oil or gas is extracted it will be a continuously stream of oil or gas.

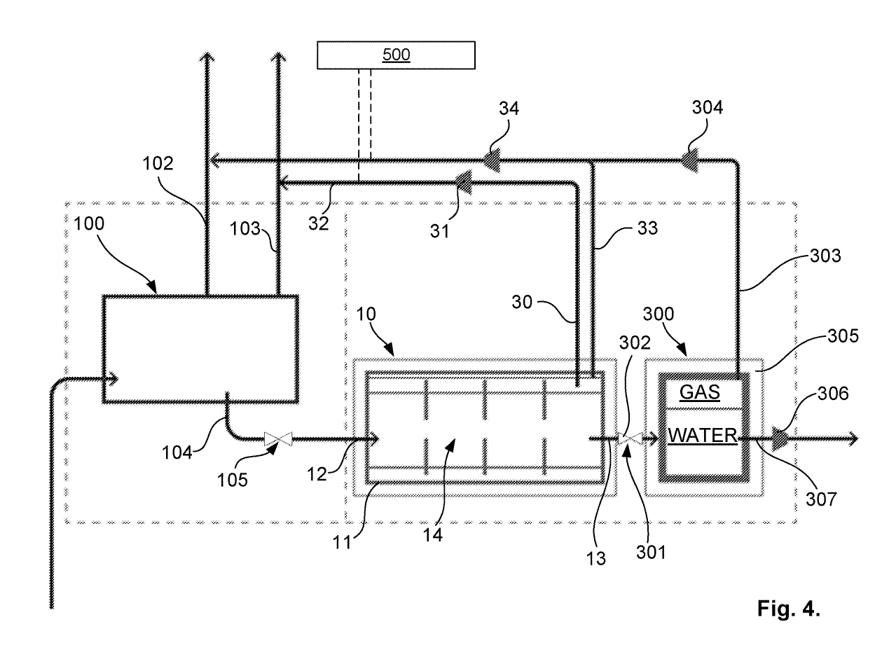

Reference is now made to FIG. 4 showing a modified embodiment of the present disclosure where the purification of the water is further enhanced with a degassing module 300 arranged to the outlet 13 of the tank assembly 10 via an inlet 308, providing degassing of remaining gas dissolved in the water 22.

While the above mentioned tank assembly 10 are formed by tanks 11/tank segments 11a designed to withstand external water pressure and operated about equilibrium pressure, the degassing module 300 can be formed by a tank 11/tank segments 11a designed to hold full external water pressure.

Accordingly, the output water from the tank assembly 10 being mainly free from oil 21, partly free from gas 20 and sand 23, is led from the outlet 13 of the tank assembly 10 via a pipe 301 (or manifold) to the degassing module (tank) 300 which is operated by adjusting temperature, pressure or supplying chemicals for releasing remaining dissolved gas. Further, it is preferably arranged a pressure relief valve 302 which causes the pressure energy to produce water droplets which enhances the release of gas from the water.

The released gas in the degassing module 300 is extracted by a pipe 303, continuously or at desired intervals, back to the main gas outlet 102 from the separator 101a, and the pressure is adapted to the pressure of the main gas outlet 102 from the separator 101a via a compressor 304 or, as shown in the figure, the pipe 303 is connected to the pipe 33 for gas from the tank assembly 10, before the compressor 34. Optionally the gas 20 is extracted continuously or at desired intervals to a surface (oil and) gas production unit 500 in the same manner as the gas 20 from the tank assembly 10. Further, as for the gas 20 in the tank assembly 10, the gas in the degassing module 300 can also be accumulated over a desired time or until the field is completed/abandoned and extracted to the surface (oil and) gas production unit 500 at this stage. The degassing module/tank 300 is preferably provided with an insulation layer 305 which will preserve the temperature from the reservoir and enhance the release of gas. As the degassing module 300, in the example, operates at low pressure, a pump 306 is preferably arranged at an outlet 307 to bring water out into the sea from the degassing module 300. The degassing module can further be provided with means for adjusting the temperature or means for supplying chemicals to operate the degassing module 300 for releasing gas.

An advantage of examples of embodiment of the present disclosure is that there is a flat roof covering the tank assembly 10, which flat roof is suitable as a platform providing space for installing other subsea equipment, such as the separators 101a-b, respective valves 105, 301, 306, pumps 31, 306 and compressors 34, 304.

A plurality of tank segments 11a may be produced on shore in an effective manner in a conveyer belt like fashion. When installing the tank segments 11a on a concrete platform on the seabed, respective manifolds, pipes and valves may be assembled afterwards. When lowering each tank segment 11a the respective tank segments 11a may be filled with water in controlled manner as known in the prior art. The same applies for lowering the entire tank assembly 10.

The last operation would be to lower a roof on top of the tank assembly 11. If it is known that the volume of produced water will increase during the production lifetime of the connected oil field it is possible to make the concrete platting 200 larger thereby enabling easy fitting of extra tank segments 11a in the future.

When the field is to be abandoned the sand in the tank assembly 10 can be brought to the surface by pumping the sand up by means of supplying seawater to the tank assembly 10 and to a surface production unit 500 arranged for purification of sand and thus extracting any remaining oil in the sand.

If the sand is considered to be clean enough and the regulations in the area permit, the tank assembly can be filled with sand from the seabed and thus covering the polluted sand, and the tank assembly thus form a deposit for polluted sand. As a further precaution the entire tank assembly can be casted in to form a secure and sealed environment for the polluted sand.

### Modifications

The tanks, compartments or tank segments can be of different shape and different volume depending on the desired properties.

The tank segments 11a or tanks 11 forming the tank assembly 10 can be either sealed tanks or tanks which are sealed by arrangement of a roof after the tank assembly 10 or tank segments 11a are arranged at the concrete platform at the seabed.

The openings 16-18 can be provided with means for opening and closing the openings and also adjusting the size of the openings if desired.

1-23. (canceled)

24. A method of subsea purification of produced water from subsea oil producing installations, comprising:
supplying separated produced water containing water and sand together with rests of oil and gas from subsea oil producing installations to an inlet at one side of a subsea tank assembly, where the inlet is arranged at a distance from upper part of the tank assembly not interfering with oil and gas phases;
separating by gravitational forces and retention time the produced water into a gas phase, oil phase and water phase, as well as sand; and
releasing purified water to surrounding sea via an outlet at opposite side of the subsea tank assembly, where the outlet is arranged at a distance from upper part of the tank assembly not interfering with the oil and gas phases.

25. The method according to claim 24, further comprising extracting separated gas by means of a gas outlet arranged in upper part of the tank assembly, the gas outlet being in communication with the gas phase.

26. The method according to claim 24, further comprising extracting separated oil by means of an oil outlet arranged in upper part of the tank assembly, the oil outlet being in communication with the oil phase.

27. The method according to claim 24, further comprising using a degassing module arranged in fluid communication with the water outlet of the tank assembly, and operating the degassing module by adjusting temperature, pressure or supplying chemicals for releasing remaining dissolved gas in the water before releasing purified water to surrounding sea.

28. The method according to claim 27, further comprising extracting separated gas from the degassing module by means of a gas outlet arranged in upper part of the degassing module.

29. The method according to claim 25, further comprising using least one compressor for extracting gas from the gas outlet of the tank assembly or gas outlet of the degassing module.

30. The method according to claim 26, further comprising using at least one pump for extracting oil from the oil outlet of the tank assembly.

31. The method according to claim 28, further comprising using a pump for extracting purified water from the degassing module.

32. The method according to claim 24, further comprising extracting gas or oil from the tank assembly continuously, accumulating gas or oil in the tank assembly for extraction at desired intervals, or after completion/abandonment of a field.

33. The method according to claim 24, further comprising setting retention time by experiment wherein a sample of produced water is kept in a glass container and measuring the time it takes for a separation by gravitational forces to occur, or by using a fluid flow or volume meter arranged to produced water of subsea oil producing installations.

34. A system for subsea purification of produced water from subsea oil producing installations, comprising:
a subsea tank assembly including at least one tank, where the tank assembly is provided with at least one inlet at one side thereof and at least one outlet at the opposite side thereof, and the tank assembly being arranged at a sea floor; wherein
the at least one inlet is arranged at a distance from upper part of the tank assembly, not interfering with oil and gas phases, for supply of produced water from the subsea oil producing installation containing water and sand together with rests of oil and gas;
the at least one outlet is arranged at a distance from upper part of the tank assembly, not interfering with oil and gas phases; and
the tank assembly separates by gravitational forces and retention time the produced water into a gas phase, oil phase and water phase, as well as sand, storing sand and other mineral particles, and releases purified water via the outlet into the surrounding sea.

35. The system according to claim 34, wherein the tank assembly is formed by a tank exhibiting at least two compartments, at least two tanks, and at least two tank segments; and wherein the respective compartments, tanks, or tank segments are arranged in fluid communication with neighboring compartments, tanks, or tank segments.

36. The system according to claim 35, wherein the fluid communication between with neighboring compartments, tanks, or tank segments is achieved by at least one opening in sidewalls thereof.

37. The system according to claim 34, wherein the tank assembly is provided with at least one oil outlet in an upper part for extracting separated oil from the tank assembly.

38. The system according to claim 34, wherein the tank assembly is provided with at least one gas outlet on a top for extracting separated gas from the tank assembly.

39. The system according to claim 34, further comprising a degassing module arranged in fluid communication with the outlet of the tank assembly; the degassing module is provided with an outlet for releasing purified water into surrounding sea, and a gas outlet at a top of the degassing module for extracting separated gas.

40. The system according to claim 34, further comprising one or more of the following:
at least one pump connected to the oil outlet for extracting oil from the tank assembly;
at least one compressor connected to the gas outlet for extracting gas from the tank assembly; and
at least one compressor connected to the gas outlet for extracting gas from the degassing module.

41. The system according to claim 39, further comprising a pump connected to the outlet of the degassing module for extracting water from the degassing module.

42. The system according to claim 34, further comprising one or more of the following:
one or more manifolds or valves arranged between a produced water output of the subsea oil producing installation and an input of the tank assembly; and
one or more manifolds or valves arranged between a water output of the tank assembly and an input of the degassing module.

43. The system according to claim 34, wherein the system is connected to a concrete platting on a seabed.
